(19) United States
(12) Patent Application Publication
(10) Pub. No.: US 2004/0201762 A1
(43) Pub. Date: Oct. 14, 2004

(54) Solid-state imaging apparatus

(75) Inventor: Yuichi Gomi, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OLYMPUS CORPORATION, Tokyo (JP)

(21) Appl. No.: 10/808,305

(22) Filed: Mar. 25, 2004

(30) Foreign Application Priority Data
Apr. 11, 2003 (JP) 2003-107475

(51) Int. Cl. H04N 5/335

(52) U.S. Cl. 348/308

(57) ABSTRACT

Disclosed herein is an XY-addressing type solid-state imaging apparatus including: a plurality of pixels arranged in a two-dimensional matrix; and a horizontal and vertical scanning circuits for reading signals of the pixels, wherein the vertical scanning circuit concurrently selects the pixels of n rows (n being an integer of 2 or more) at a first timing to concurrently effect a reset operation of the pixels of the n rows thereof and selects at a second timing subsequent to the first timing the pixels of n rows of the address different from the rows selected at the first timing to effect a reset operation of the pixels of the n rows thereof, reset operation in this manner being repeated to effect a reset operation of all pixels.

This application claims benefit of Japanese Patent Application No. 2003-107475 filed in Japan on Apr. 11, 2003, the contents of which are incorporated by theis reference.

### BACKGROUND OF THE INVENTION

The present invention relates to XY-addressing type solid-state imaging apparatus in which reset operation of all pixels is effected at high speed.

FIG. 1 is a circuit diagram showing an example of the construction of conventional XY-addressing type solid-state imaging apparatus. Referring to FIG. 1, Pix(1,1), Pix(2,1), . . . Pix(m,n), represent pixels. Here an example arranged in m (columns) and n (rows) is shown. Each pixel includes one photodiode and three MOS transistors. A photodiode 1 is connected to the source of a reset MOS transistor 2 having its gate connected in common row by row and to the gate of an amplifying MOS transistor 3. The gate of the reset MOS transistor 2 connected in common row by row is connected to a vertical scanning circuit 21. The drains of the reset MOS transistor 2 and the amplifying MOS transistor 3 are both connected to a pixel power supply 23 which is common to all pixels, and the source of the amplifying MOS transistor 3 is connected to the drain of a row selection MOS transistor 4 having its gate connected in common row by row.

The gate of the row selection MOS transistor 4 connected in common row by row is connected to the vertical scanning circuit 21. The source of the row selection MOS transistor 4 is connected to a vertical signal line 10 so that the pixels are coupled to each other column by column through the vertical signal line 10. Connected to the vertical signal line 10 is a current source 24 which constitutes a source follower circuit together with the amplifying MOS transistor 3 in pixel.

Further, the vertical signal line 10 is connected to the drain of a signal transmitting MOS transistor 6. The gate of the signal transmitting MOS transistor 6 is connected in common with each other to which a transmitting signal ΦT is applied. A signal accumulation capacitor 8 is connected to the source of the signal transmitting MOS transistor 6, and the source is connected to the drain of a horizontal selection MOS transistor 5. The horizontal selection MOS transistor 5 is connected at the gate thereof to a horizontal scanning circuit 22 and at the source thereof to a horizontal signal line 11. Connected to the horizontal signal line 11 are a horizontal signal line reset MOS transistor 7 and an output amplifier 25.

In thus constructed solid-state imaging apparatus, the reset MOS transistor 2 and row selection MOS transistor 4 are controlled row by row based on the signals from the vertical scanning circuit 21 so that photodiode 1 is reset row by row to the level of the pixel power supply 23 and accumulates charge corresponding to an amount of incident light. The signal level thereof then occurs row by row on the vertical signal line 10 as amplified by the source follower circuit and is accumulated at the signal accumulation capacitor 8.

Subsequently, ON/OFF of the horizontal selection MOS transistor 5 is sequentially controlled by the horizontal scanning circuit 22 and the horizontal signal line is reset by the horizontal signal line reset transistor 7 so that signals corresponding to the amount of incident light accumulated at the signal accumulation capacitor 8 are sequentially fetched from an output terminal 26 through the output amplifier 25.

An operation of the solid-state imaging apparatus shown in FIG. 1 will now be described in detail by way of a timing chart shown in FIG. 2. Here, ΦSE1 to ΦSEn are the pulses to be applied to the gate of the row selection MOS transistor 4 of each pixel row, and ΦRS1 to ΦRSn are the pulses to be applied to the gate of the reset MOS transistor 2. These pulses ΦSE1 to ΦSEn and ΦRS1 to ΦRSn are generated at the vertical scanning circuit 21. Further, ΦH1 to ΦHm are generated at the horizontal scanning circuit 22 and are applied to the gate of each horizontal selection transistor 5. “ΦT” is a transmitting signal which is applied on the gate of the signal transmitting MOS transistor 6.

In the operation of pixels Pix(1, 1) . . . Pix(m,1) of the first row, pulse ΦRS1 is first driven to high level at time t1 so that the reset MOS transistor 2 is turned ON to reset photodiode 1. It is then turned into the accumulating condition. At time t2, then, pulse ΦSE1 is driven to high level to turn ON the row selection MOS transistor 4 so that the level of photodiode 1 at that time is caused occur on the vertical signal line 10. Further, at this time, since the transmitting signal pulse ΦT is also driven to high level, the signal occurring on the vertical signal line 10 is accumulated at the accumulation capacitor 8. After the termination of the accumulation of the pixel signal to the accumulation capacitor 8 at time t3, ΦRS1 is driven to high level at time t4 so that the photodiode is reset and subsequently brought into the accumulating condition.

The signal accumulated at the accumulation capacitor 8 occurs on the horizontal signal line 11, as pulse ΦH1 is driven to high level at time t5 to turn ON the horizontal selection MOS transistor 5 of the first column. It is then fetched from the output terminal 26 through the output amplifier 25. Subsequently, though not shown in FIG. 2, after turning ON the horizontal signal line reset MOS transistor 7 to reset the horizontal signal line 11, pulse ΦH2 is driven to high level so as to fetch the signal of the second column accumulated at the accumulation capacitor 8. Thereafter, in a similar manner, the signals of the third to m'th columns are sequentially outputted in synchronization with pulses ΦH3 to ΦHm.

In like manner, the pixel signals of the second row are outputted by control of pulses ΦRS2, ΦSE2, ΦH1, . . . ΦHm. All pixel signals of m columns and n rows can be outputted by effecting similar control up to n'th row.

If the operation is started from time t0 in FIG. 2, those output signals in the period referred to as 1st frame are the signals to which charges remaining on the pixels up to just before the operation are added and thus cannot be used as image signals.

Further, in FIG. 2, the accumulation period of the pixels of the first row is from t1 to t2, and the accumulation period of the pixels of the second row is from t6 to t7. Accordingly, each point in time of the accumulation period is different from one row to another, resulting in the phenomenon that image is distorted when the image is taken of a moving object. To make uniform the accumulation period of each row, therefore, an operation sequence as shown in FIG. 3 using a mechanical shutter or lighting is sometimes used especially when an intermittent operation is effected as in the case of a still picture. Referring to FIG. 3, reset operation of the pixels is started from time t0 and the pixel reset operation is terminated at time t1. An accumulation period then starts and pixel signals are outputted at t2 after the passage of a desired accumulation time. In this case, the pixel reset period and the pixel signal output period are in dark condition and only the accumulation period is in a lighted condition. The conditions of dark and light can be produced by using a mechanical shutter which opens only during the accumulation period or a lighting which lights only during such period. Here, the operation during the pixel reset period corresponds to the operation in 1st frame in FIG. 2, and the operation in the signal output period corresponds to the operation in 2nd frame in FIG. 2. In the pixel reset period, however, the signals are not required to be outputted as described in Japanese Patent Application Laid-Open Hei-10-178589.

### SUMMARY OF THE INVENTION

It is an object of the present invention to provide a solid-state imaging apparatus in which pixel reset can be effected at high speed even for an increased number of pixels.

In a first aspect of the solid-state imaging apparatus according to the invention, there is provided an XY-addressing type solid-state imaging apparatus including: a plurality of pixels arranged in a two-dimensional matrix; and a horizontal scanning circuit and a vertical scanning circuit for reading signals of the pixels. The vertical scanning circuit concurrently selects the pixels of n rows (n being an integer of 2 or more) at a first timing to concurrently effect a reset operation of the pixels of the n rows thereof and selects at a second timing subsequent to the first timing the pixels of n rows of the address different from the rows selected at the first timing to effect a reset operation of the pixels of the n rows thereof. The reset operation in this manner is repeated to effect a reset operation of all pixels.

In a second aspect of the invention, the pixels of the n rows concurrently selected for the reset operation to be effected in the solid-state imaging apparatus according to the first aspect are the pixels of the rows having consecutive addresses.

In a third aspect of the invention, the pixels of the n rows concurrently selected for the reset operation of the pixels to be effected in the solid-state imaging apparatus according to the first aspect are the pixels of the rows having discrete addresses.

In a fourth aspect of the invention, the vertical scanning circuit in the solid-state imaging apparatus according to any one of the first to third aspects includes: a row selecting section; and a timing pulse generating section to which output signals of the row selecting section and timing signals are inputted to generate control signals for effecting pixel operation.

In a fifth aspect of the invention, the row selecting section in the solid-state imaging apparatus according to the fourth aspect includes a decoder.

In a sixth aspect of the invention, the row selecting section in the solid-state imaging apparatus according to the fourth aspect includes a shift register.

In a seventh aspect of the invention, the timing pulse generating section in the solid-state imaging apparatus according to any one of the fourth to sixth aspects includes a logic circuit.

### BRIEF DESCRIPTION OF THE DRAWINGS

FIG. 1 is a circuit diagram showing an example of the construction of conventional solid-state imaging apparatus.

FIG. 2 is a timing chart for explaining operation of the solid-state imaging apparatus shown in FIG. 1.

FIG. 3 shows an operation sequence in the case where a mechanical shutter or lighting is used to make uniform the accumulation period of the pixels of each row in the solid-state imaging apparatus shown in FIG. 1.

FIG. 4 is a circuit diagram showing a fundamental construction of a first embodiment of the solid-state imaging apparatus according to the invention.

FIG. 5 shows a portion of a specific example of the vertical scanning circuit of the solid-state imaging apparatus according to the first embodiment shown in FIG. 4.

FIG. 6 is a timing chart for explaining operation of the solid-state imaging apparatus according to the first embodiment shown in FIG. 4.

FIG. 7 shows a specific example of the row selecting section of the vertical scanning circuit shown in FIG. 5.

FIG. 8 is a circuit diagram showing a fundamental construction of the shift register of the row selecting section shown in FIG. 7.

FIG. 9 is a conceptual diagram typically showing the shift register shown in FIG. 8.

FIG. 10 is a timing chart for explaining operation of the shift register shown in FIG. 8.

FIG. 11 is a timing chart for explaining operation in the signal output period of the shift register shown in FIG. 7.

FIG. 12 is a timing chart for explaining operation during the pixel reset period of the shift register shown in FIG. 7.

FIG. 13 is a timing chart for explaining operation of a second embodiment of the invention.

FIG. 14 is a schematic block diagram showing construction of the row selecting section of the vertical scanning circuit of the solid-state imaging apparatus according to the second embodiment.

FIG. 15 shows a specific. example of the shift register of the row selecting section shown in FIG. 14.

### DESCRIPTION OF THE PREFERRED EMBODIMENTS

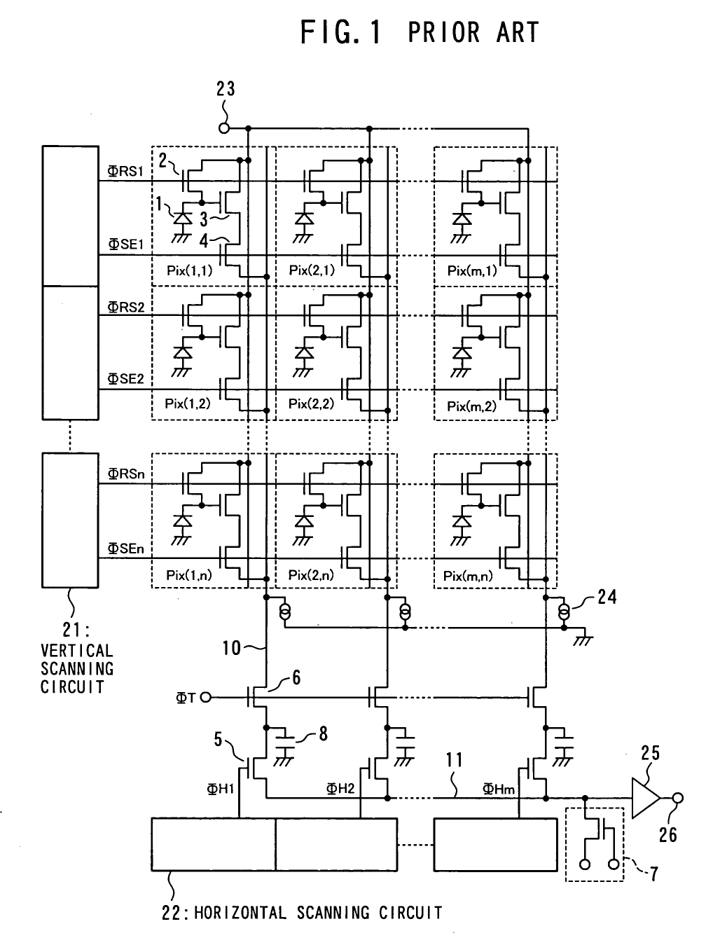

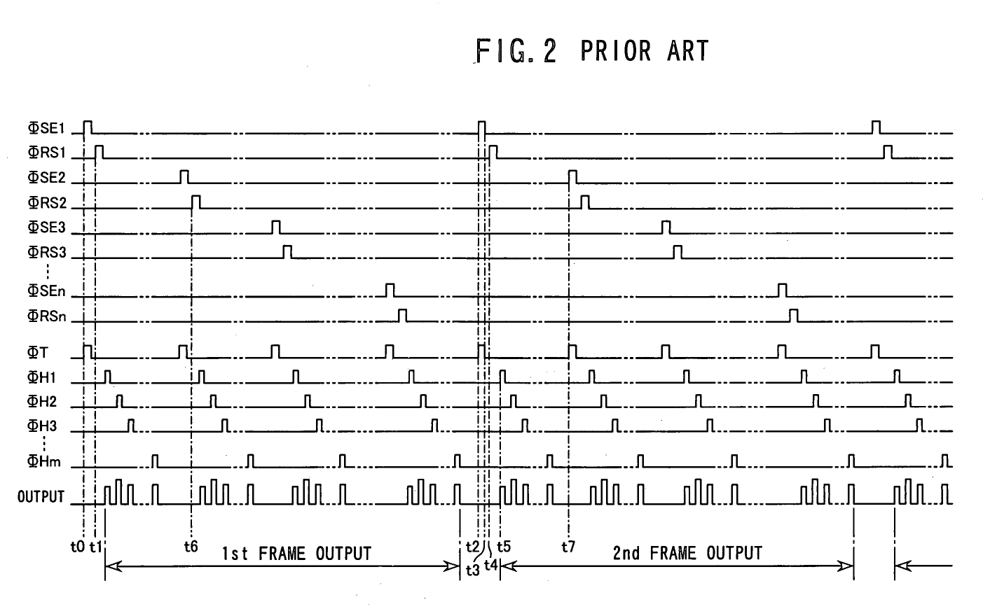

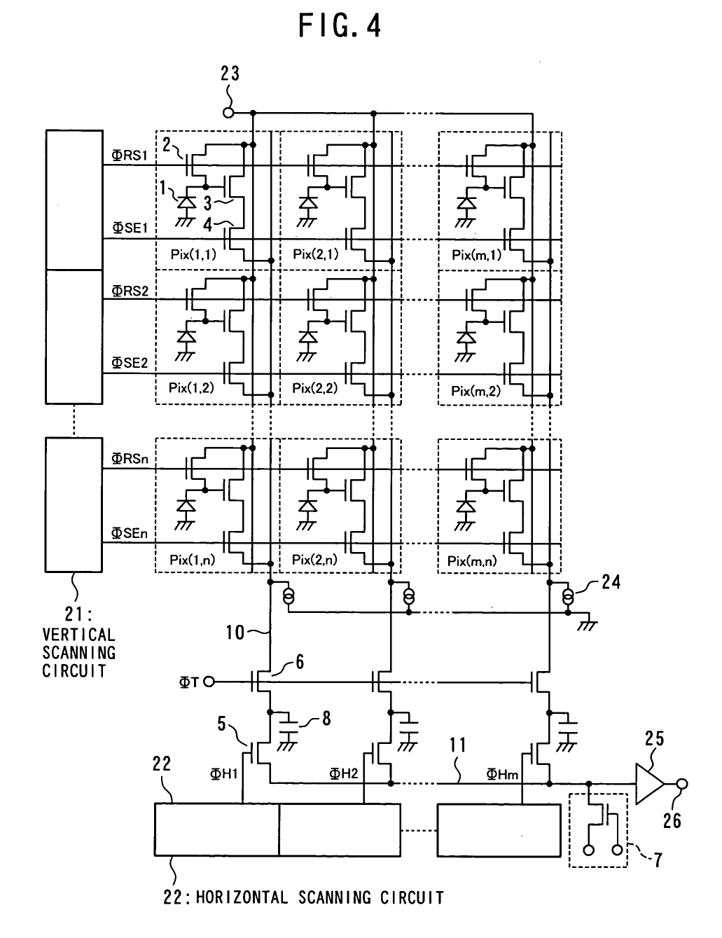

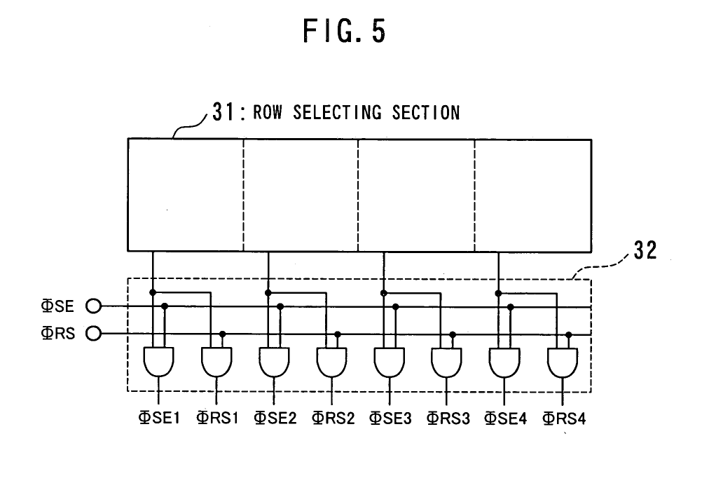

Some embodiments of the invention will now be described. Shown in FIG. 4 is a fundamental construction of a first embodiment of the solid-state imaging apparatus according to the invention. The fundamental construction shown in FIG. 4 is identical to the conventional example shown in FIG. 1 except that there is a difference in the specific construction of a vertical scanning circuit 21. The construction of the other portions thereof thus will not be described in detail. FIG. 5 shows an example corresponding to four rows of the construction of the vertical scanning circuit 21 to be used in the solid-state imaging apparatus according to the first embodiment shown in FIG. 4. The vertical scanning circuit 21 includes: a row selecting section 31 for outputting pulses in accordance with a certain rule; and a timing pulse generating section 32 to which output signals of the row selecting section 31 and timing signals ΦSE, ΦRS are inputted to generate signals ΦSE1/ΦRS1, . . . ΦSE4/ΦRS4 which are suitable for example to select/reset pixels. A shift register or decoder circuit is used as the row selecting section 31. Further, while the timing pulse generating section 32 formed by AND circuit is shown in the illustrated example, it can also be formed by other logic circuits. In the case of using thus constructed vertical scanning circuit, desired rows can be selected/scanned in a desired sequence by controlling the row selecting section 31.

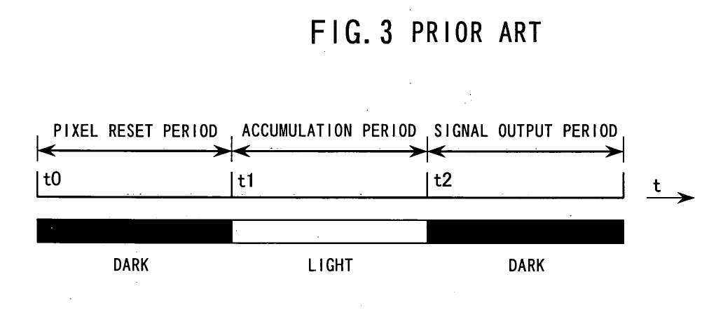

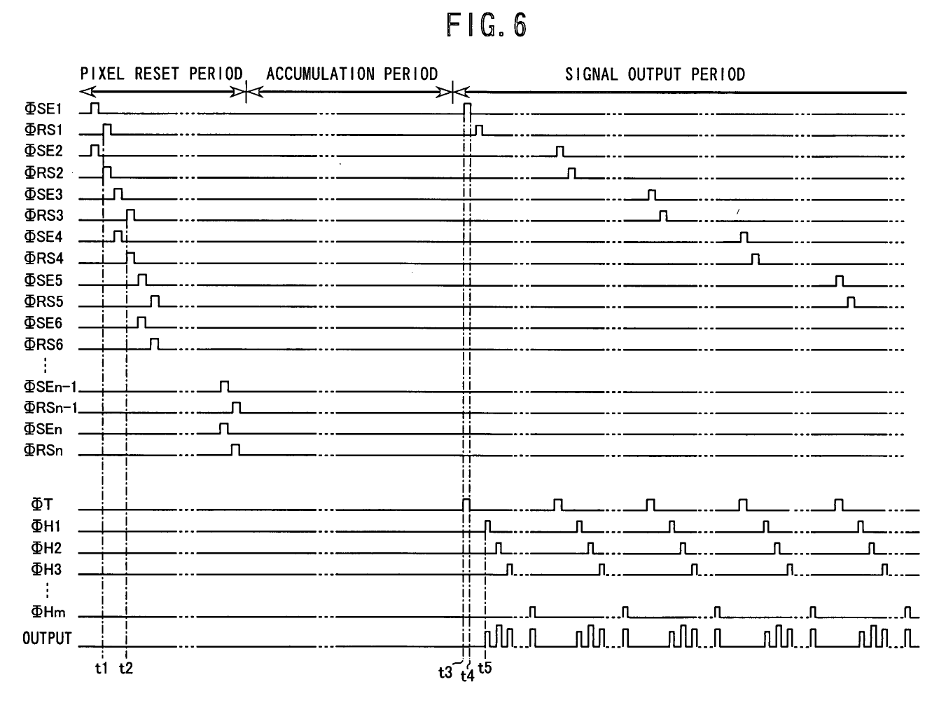

A description will now be given by way of the timing chart shown in FIG. 6 with respect to the operation of the first embodiment of the invention in the case of using the vertical scanning circuit of the above described construction in the solid-state imaging apparatus shown in FIG. 4. The operation timing shown in FIG. 6 is of the case where the operation is effected in the sequence shown in FIG. 3. Referring to FIG. 6, ΦSE1 to ΦSEn are pulses to be applied on the gate of the row selection MOS transistor 4 of each pixel row, and ΦRS1 to ΦRSn are pulses to be applied on the gate of the reset MOS transistor 2. These pulses ΦSE1 to ΦSEn and ΦRS1 to ΦRSn are generated at the vertical scanning circuit 21. Further, Φ1 to ΦHm are generated at the horizontal scanning circuit 22 and are applied on the gate of the horizontal selection transistor 5. The ΦT denotes a transmitting signal which is applied on the gate of the signal transmitting MOS transistor 6.

In a pixel reset period, pulses ΦRS1 and ΦRS2 of the first and second rows are driven to high level at time t1 so that the reset MOS transistors 2 of the first and second rows are turned ON to reset photodiodes 1 of the first and second rows. Subsequently, pulses ΦRS3 and ΦRS4 of the third and fourth rows are driven to high level at time t2 so that the reset MOS transistors 2 of the third and fourth rows are turned ON to reset photodiodes 1 of the third and fourth rows. Thereafter, in a similar manner, photodiodes 1 are sequentially reset by two rows at a time. In this reset period, since signals are not required to be outputted, all of ΦH1 to ΦHm are kept to low level. Further, it is also safe to keep ΦSE1 to ΦSEn and ΦT to low level at all times during the reset period. This can be readily effected by controlling timing signals ΦSE, ΦRS to be inputted to the timing pulse generating section 32.

In this reset period, since reset is effected of adjacent two rows at a time, it is possible to complete reset operation of all pixels by one half of the time as compared to the case of resetting row by row. The system enters an accumulation period when the reset period is terminated. For this accumulation period, a desired accumulation period can be obtained by as previously described using a mechanical shutter or lighting.

Upon the termination of the accumulation period, the system enters a signal output period. In the signal output period, pulse ΦSE1 is driven to high level at time t3 so that the row selection MOS transistor 4 of the first row is turned ON. The level of photodiode 1 of the first row at that time occurs on the vertical signal line 10. At this time, since the transmitting signal pulse ΦT is also driven to high level, the signal occurring on the vertical signal line 10 is accumulated at the accumulation capacitor 8. After terminating the accumulation of the pixel signal to the accumulation capacitor 8 at time t4, pulse ΦH1 is driven to high level at time t5 to turn ON the horizontal selection MOS transistor 5 of the first column so that the signal accumulated at the accumulation capacitor 8 is caused to occur on the horizontal signal line 11. It is then fetched from the output terminal 26 through the output amplifier 25. Subsequently, though not shown in FIG. 6, after turning ON the horizontal signal line reset MOS transistor 7 to reset the horizontal signal line 11, pulse ΦH2 is driven to high level so as to fetch the signal of the second column accumulated at the accumulation capacitor 8. Thereafter, in a similar manner, the signals of the third to m'th columns are sequentially outputted in synchronization with pulses ΦH3 to ΦHm.

Similarly, the pixel signals of the second row are outputted as controlled by pulses ΦRS2, ΦSE2, ΦH1 to ΦHm. By then effecting similar control up to the n'th row, all pixel signals of m columns and n rows can be outputted.

In this manner, it is possible by causing operation as shown in FIG. 6 to make shorter the pixel reset period which is essentially an unnecessary period for the system. The number of pixel rows to be concurrently reset in the reset period includes but not limited to the case of two rows as shown in the present embodiment, and an all-pixel reset can be effected in a shorter time duration by increasing the number of rows thereof. Accordingly, even when pixels are increased in number, an increase in the time required for resetting all pixels can be controlled by changing the number of pixel rows to be concurrently reset. It should be noted that the fundamental construction of the solid-state imaging apparatus includes but not limited to that shown in the embodiment of FIG. 4, and those solid-state imaging apparatus of the so-called X-Y addressing type can obviously be used.

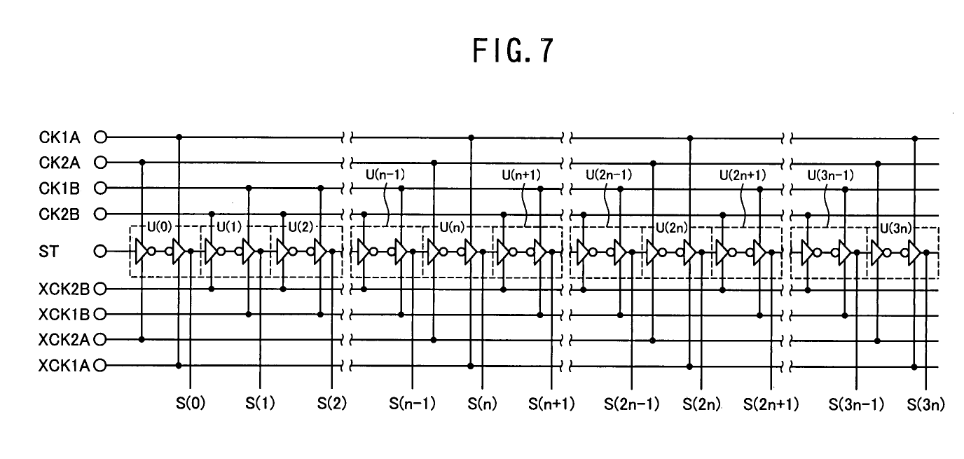

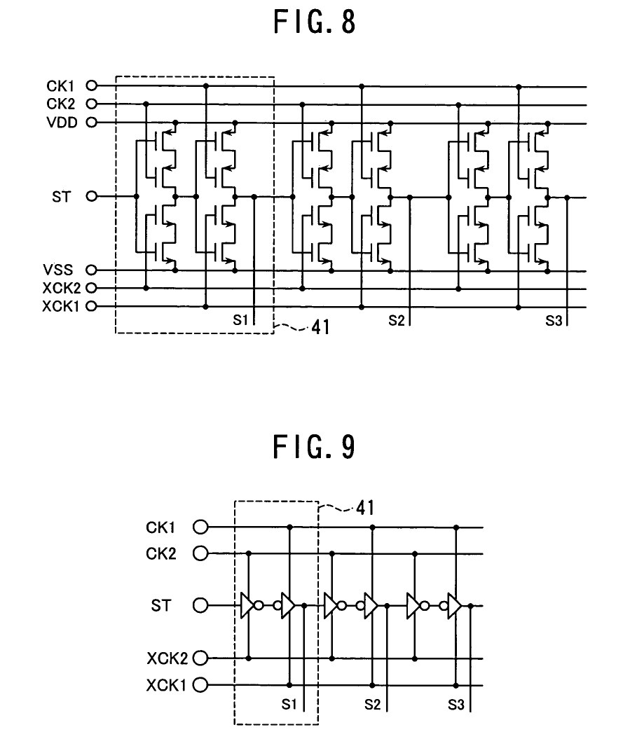

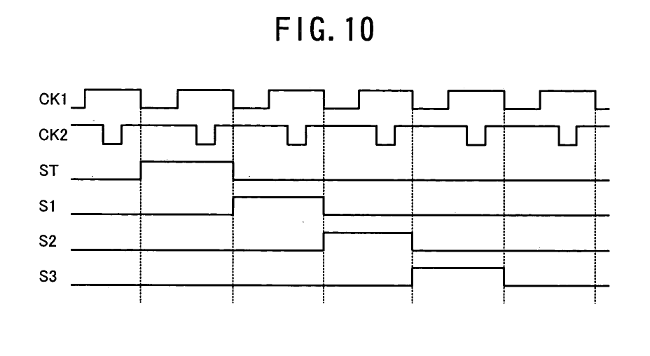

As a specific example of the row selecting section 31 of the vertical scanning circuit shown in FIG. 5 for effecting the above described operation, a shift register is disclosed in Japanese patent application laid-open Hei-9-200615 by the present applicant. FIG. 7 shows the construction of such a register. A description will be given first by way of FIG. 8 with respect to the components of the shift register shown in FIG. 7. The components of the shift register are of the configuration where two stages of clocked inverters constitute one shift register unit 41 which is typically represented as shown in the conceptual drawing of FIG. 9. The operation timing thereof is shown in FIG. 10. The clock signal contains two phases of CK1 and CK2 so that, upon an application of start signal ST on the input terminal of the shift register unit 41 of the first stage, outputs S1, S2, S3, . . . are sequentially outputted from the output terminal of each shift register unit 41 in synchronization with the trailing edge of clock signal CK1. It should be noted that XCK1, XCK2 indicate the inverting signals of CK1, CK2, respectively.

A description will now be given with respect to the construction of the shift register of the row selecting section 31 shown in FIG. 7. Referring to FIG. 7, the two-phase clock signals CK1, CK2 are divided to two systems of A and B. Those shift register units corresponding to n stages, U(0), U(n), U(2n), . . . are driven by the clock signals of A system (CK1A, CK2A), and the remaining other shift register units U(1), U(2), U(n−1), U(n+1), . . . are driven by the clock signals of B system (CK1B, CK2B).

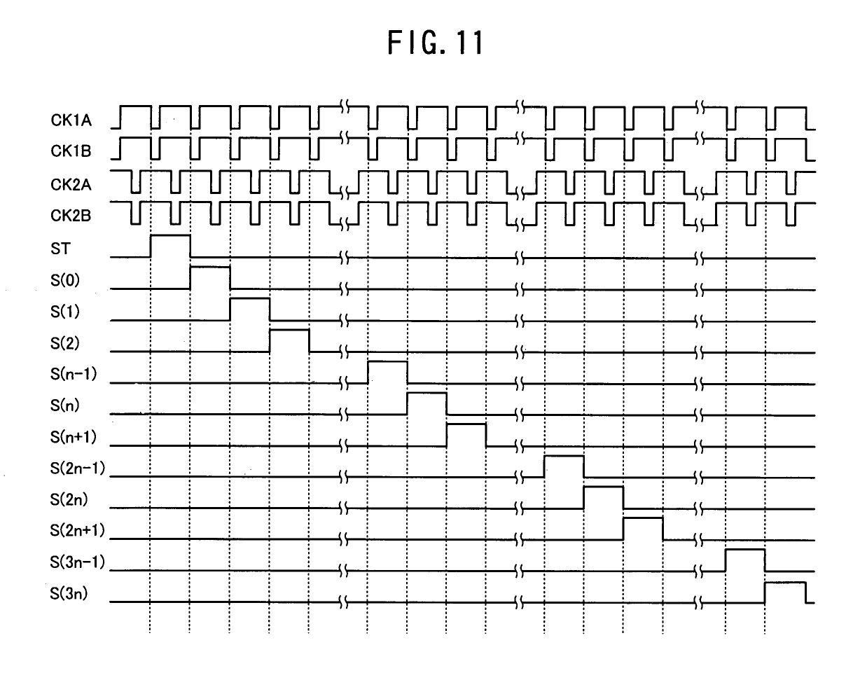

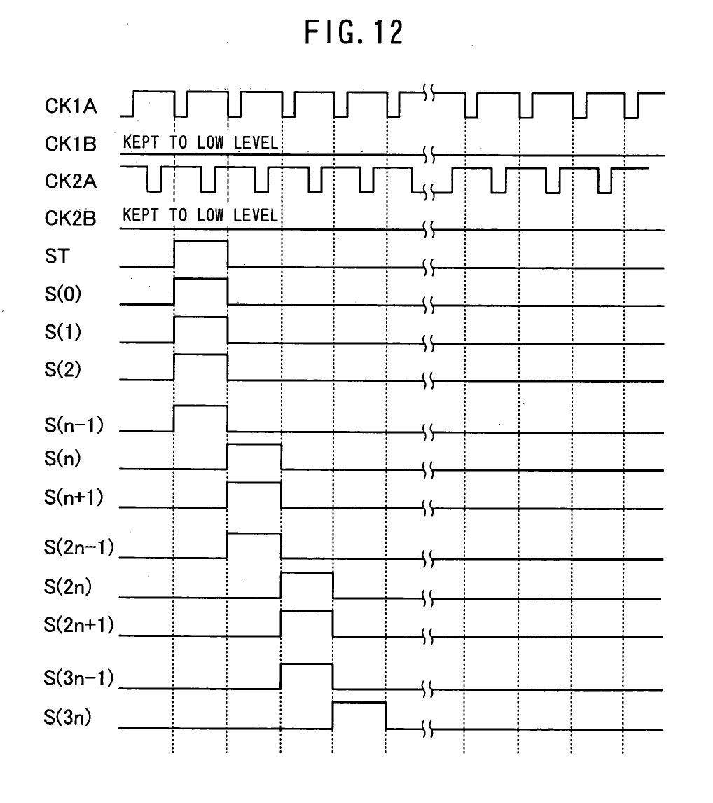

FIGS. 11 and 12 each are a timing chart for explaining operation of the shift register shown in FIG. 7. In the operation shown in FIG. 11, the clock signals of the two systems (CK1A, CK2A) and (CK1B, CK2B) are made identical to each other so that outputs S(0), S(1), S(2), S(n−1), . . . are sequentially outputted from the respective shift register units U(0), U(1), U(2), U(n−1), . . . in synchronization with the trailing edge of CK1A and CK1B similarly to the timing chart shown in FIG. 10. This operation mode is used in the signal output period.

In the operation shown in FIG. 12, the clock signals of B system (CK1B, CK2B) are fixed to low level, and the clock signals of A system (CK1A, CK2A) are made identical to that in the timing chart shown in FIG. 11. In this case, at the units U(1), U(2), U(n−1), U(n+1), . . . to which the clock signals of B system (CK1B, CK2B) are to be inputted, the two clocked inverters of each unit are caused to operate as a simple inverter. As a result, the outputs S(1), S(2), S(n−1), S(n+1), of these shift register units U(1), U(2), U(n−1), U(n+1), . . . become identical to the output of the shift register unit of the preceding stage. In particular, S(1) through S(n−1) become identical to S(O), S(n+1) through S(2n−1) to S(n), S(2n+1) through S(3n−1) to S(2n), etc. This operation mode is used in the pixel reset period.

The construction of the shift register unit to be used in the row selecting section 31 is not limited to this example. Further, the construction of the vertical scanning circuit 21 is not necessarily constituted by the row selecting section 31 and timing pulse generating section 32 as shown in FIG. 5, and it is obviously only required to be capable of switching scanning mode between the pixel reset period and the signal read out period.

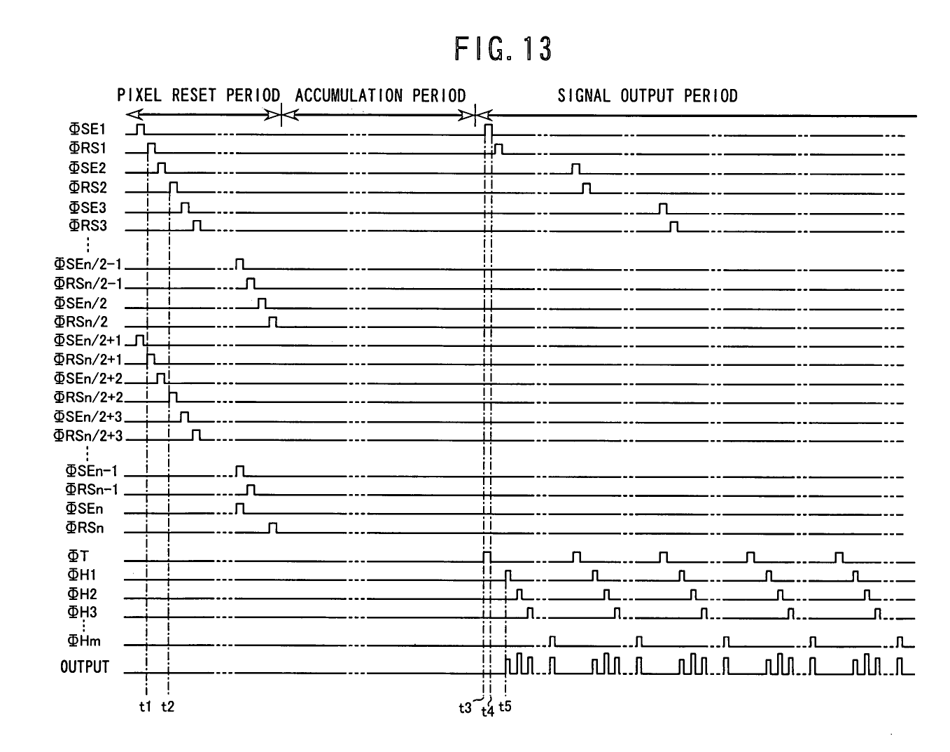

A second embodiment will now be described. A fundamental construction of the solid-state imaging apparatus according to the second embodiment of the invention is, similarly to the first embodiment, identical to that shown in FIG. 1 (FIG. 4). Further, a specific fundamental construction of the vertical scanning circuit thereof is also identical to that of the first embodiment shown in FIG. 5. Shown in FIG. 13 is an operation timing chart of the second embodiment of the invention in the case where the solid-state imaging apparatus of the fundamental construction shown in FIG. 4 is used. The operation shown in FIG. 13 is also of the case where operation is effected in the sequence shown in FIG. 3. Referring to FIG. 13, ΦSE1 to ΦSEn are the pulses to be applied on the gate of the row selection MOS transistor 4 of each pixel row, and ΦRS1 to ΦRSn are the pulses to be applied on the gate of the reset MOS transistor 2. These pulses ΦSE1 to ΦSEn and ΦRS1 to ΦRSn are generated at the vertical scanning circuit 21. Further, ΦH1 to ΦHm are generated at the horizontal scanning circuit 22 and are applied on the gate of the horizontal selection transistor 5. “ΦT” is a transmitting signal which is applied on the gate of the signal transmitting MOS transistor 6.

In the pixel reset period, pulses ΦRS1 and ΦRSn/2+1 of the first row and n/2+1'th row are driven to high level at time t1 so that the reset MOS transistors 2 of the first row and n/2+1'th row are turned ON to reset photodiodes 1 of the first row and n/2+1'th row. Subsequently, pulses ΦRS2 and ΦRSn/2+2 of the second row and n/2+2'th row are driven to high level at time t2 so that the reset MOS transistors 2 of the second row and n/2+2'th row are turned ON to reset photodiodes 1 of the second row and n/2+2'th row. Thereafter, in a similar manner, photodiodes 1 are sequentially reset by two rows at a time. In this reset period, since signals are not required to be outputted, all of ΦH1 to ΦHm are driven to low level. Further, it is also safe to keep ΦSE1 to ΦSEn and ΦT to low level at all times during the reset period. This can be readily effected by controlling timing signals to be inputted to the timing pulse generating section 32.

In this reset period of the second embodiment, since reset is effected, though discretely, by two rows at a time similarly to the first embodiment, it is possible to complete a reset operation of all pixels by one half of the time as compared to the case of resetting row by row. The system enters an accumulation period when the reset period is terminated. For this accumulation period, a desired accumulation period can be obtained by as previously described using a mechanical shutter or lighting.

Upon termination of the accumulation period, the system enters a signal output period. In the signal output period, pulse ΦSE1 is driven to high level at time t3 so that the row selection MOS transistor 4 of the first row is turned ON. The level of photodiode 1 of the first row at that time occurs on the vertical signal line 10. At this time, since the transmitting signal pulse ΦT is also driven to high level, the signal occurring on the vertical signal line 10 is accumulated at the accumulation capacitor 8. After terminating the accumulation of the pixel signal to the accumulation capacitor 8 at time t4, pulse ΦH1 is driven to high level at time t5 to turn ON the horizontal selection MOS transistor 5 of the first column so that the signal accumulated at the accumulation capacitor 8 is caused to occur on the horizontal signal line 11. It is then fetched from the output terminal 26 through the output amplifier 25. Subsequently, though not shown in FIG. 13, after turning ON the horizontal signal line reset MOS transistor 7 to reset the horizontal signal line 11, pulse ΦH2 is driven to high level so as to fetch the signal of the second column accumulated at the accumulation capacitor 8. Thereafter, in a similar manner, the signals of the third to m'th columns are sequentially outputted in synchronization with pulses ΦH3 to ΦHm.

Similarly, the pixel signals of the second row are outputted as controlled by pulses ΦRS2, ΦSE2, ΦH1 to ΦHm. By then effecting similar control up to the n'th row, all pixel signals of m columns and n rows can be outputted.

By effecting operation as shown in FIG. 13, it is possible to make shorter the pixel reset period which is essentially an unnecessary period for the system. The number of pixel rows to be concurrently reset in the reset period includes but not limited to the case of two rows as shown in the present embodiment, and an all-pixel reset can be effected in a shorter time duration by increasing the number of rows thereof. Accordingly, even when pixels are increased in number, an increase in the time required for resetting all pixels can be controlled by changing the number of pixel rows to be concurrently reset. Further, the fundamental construction of the solid-state imaging apparatus includes but not limited to that shown in the present embodiment, and those solid-state imaging apparatus of the so-called X-Y addressing type can obviously be used.

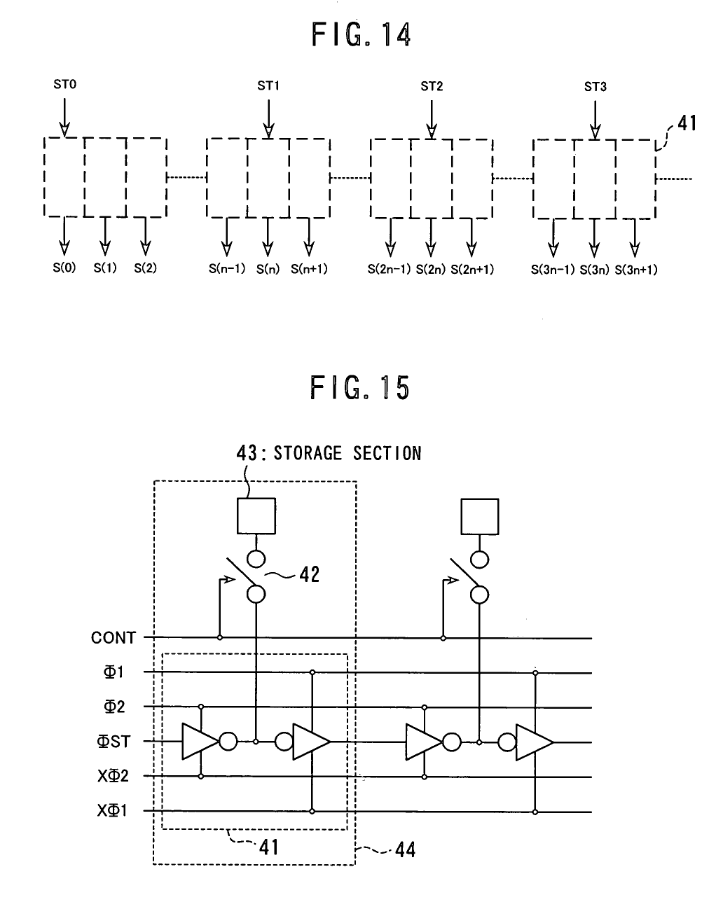

The row selecting section 31 for effecting the operation as described above is constructed by providing start pulse inputting location at a plurality of stages of shift register unit 41 as shown in FIG. 14. A desired operation then becomes possible such that scanning in the pixel reset period is started concurrently from such plurality of start pulse inputting locations, while, in the signal output period, scanning is effected by inputting start signal ST0 to only the first one start pulse inputting location. A specific construction of the row selecting section 31 can be achieved by using a shift register as disclosed in Japanese patent application laid-open Hei-4-277986 filed by the present applicant.

Further, as other specific examples, it is also possible to use a shift registers as disclosed in Japanese patent application laid-open Hei-6-350933 or Japanese patent application laid-open Hei-9-163244 filed by the present applicant. An example thereof is shown in FIG. 15. FIG. 15 includes: 41, a shift register unit constituted by serially connecting two clocked inverters; 42 a bidirectional switch controlled by control signal CONT; 43, a storage section; and 44, a unit block of shift register consisting of the shift register unit 41, bidirectional switch 42, and storage section 43. The shift register is constructed by a cascade connection of a plurality of thus constructed unit block 44.

The operation of the shift register having such construction will now be described. In such shift register, start pulse ΦST is inputted and shifted by clocks Φ1, Φ2 in a pre-scanning to be performed prior to an actual main scanning. At a point in time when the start pulse is shifted to a desired location for starting scanning in the main scanning, the bidirectional switch 42 is turned ON by the control signal CONT so as to store information of each shift register unit 41 to the storage section 43. The scanning can be stared from the desired location such that, before the start of the main scanning, the bidirectional switch 42 is turned ON again by control signal CONT to transmit information stored at the storage section 43 to the shift register unit 41, and the main scanning is then effected by driving the shift register.

In the case of using such shift register, a plurality of rows can be concurrently reset in the pixel reset period by effecting the main scanning after storing start location information to a plurality of storage sections through the pre-scanning. In the signal output period, on the other hand, signals of all pixels can be read by performing a main scanning from the first stage without performing a pre-scanning.

The construction of the shift register to be used in the row selecting section includes but not limited to these examples of construction. Further, the construction of the vertical scanning circuit is not necessarily required to be constituted by the row selecting section and the timing pulse generating section, and it is obviously only required to be capable of switching the scanning mode between the pixel reset period and the signal read out period.

As has been described by way of the above embodiments, according to the invention, the pixels of a plurality of rows can be concurrently reset so that reset operation of all pixels is completed by a smaller number of shift operation of the vertical scanning circuit than the number of pixel rows. The time required for resetting all the pixels thus can be reduced. Further, the number of rows to be concurrently selected can be increased so as to avoid an increase in the reset time of all pixels even when the number of pixels is increased. Furthermore, a reset time of all pixels without depending on the number of pixels can be obtained by adjusting the number of pixel rows to be concurrently reset.

What is claimed is:

1. An XY-addressing type solid-state imaging apparatus comprising:
a plurality of pixels arranged in a two-dimensional matrix; and
a horizontal scanning circuit and a vertical scanning circuit for reading signals of the pixels;
wherein said vertical scanning circuit concurrently selects the pixels of n rows (n being an integer of 2 or more) at a first timing to concurrently effect a reset operation of the pixels of the n rows thereof and selects at a second timing subsequent to the first timing the pixels of n rows of the address different from the rows selected at the first timing to effect a reset operation of the pixels of the n rows thereof, reset operation in this manner being repeated to effect a reset operation of all pixels.

2. The solid-state imaging apparatus according to claim 1, wherein said pixels of the n rows concurrently selected for the reset operation to be effected are the pixels of the rows having consecutive addresses.

3. The solid-state imaging apparatus according to claim 1, wherein said pixels of the n rows concurrently selected for the reset operation to be effected are the pixels of the rows having discrete addresses.

4. The solid-state imaging apparatus according to any one of claims 1 to 3, wherein said vertical scanning circuit comprises: a row selecting section; and a timing pulse generating section to which output signals of the row selecting section and timing signals are inputted to generate control signals for effecting pixel operation.

5. The solid-state imaging apparatus according to claim 4, wherein said row selecting section comprises a decoder.

6. The solid-state imaging apparatus according to claim 4, wherein said row selecting section comprises a shift register.

7. The solid state imaging apparatus according to claim 4, wherein said timing pulse generating section comprises a logic circuit.

8. The solid state imaging apparatus according to claim 5, wherein said timing pulse generating section comprises a logic circuit.

9. The solid state imaging apparatus according to claim 6, wherein said timing pulse generating section comprises a logic circuit.
